(19) United States
(12) Patent Application Publication
(10) Pub. No.: US 2026/0088328 A1
(43) Pub. Date: Mar. 26, 2026

(54) APPARATUS AND METHOD FOR MANUFACTURING SECONDARY BATTERY

(71) Applicant: SAMSUNG SDI CO., LTD., Yongin-si (KR)

(72) Inventor: Ki Jeong LEE, Suwon-si (KR)

(21) Appl. No.: 19/277,595

(22) Filed: Jul. 23, 2025

(30) Foreign Application Priority Data
Sep. 24, 2024 (KR) 10-2024-0129454

(51) Int. Cl. H01M 10/04; H01M 50/533

(52) U.S. Cl. CPC H01M 10/0409; H01M 10/0422; H01M 50/533

(57) ABSTRACT

An apparatus for manufacturing a secondary battery includes a cap jig configured to move and contact a cap assembly, a guide jig configured to move and contact one side of an electrode tab that electrically connects the cap assembly to an electrode assembly, and a roller jig configured to move and contact other side of the electrode tab.

### CROSS-REFERENCE TO RELATED APPLICATION

The present application claims priority and the benefit of Korean Patent Application No. 10-2024-0129454, filed on Sep. 24, 2024, in the Korean Intellectual Property Office, the entire disclosure of which is incorporated herein by reference.

### BACKGROUND

### 1. Field

The present disclosure relates to an apparatus and method for manufacturing a secondary battery.

### 2. Description of the Related Art

Secondary batteries are batteries that can be (re) charged and discharged unlike primary batteries that cannot be recharged. Low-capacity secondary batteries may be used in small portable electronic devices such as smartphones, feature phones, laptop computers, digital cameras, and camcorders, and large-capacity secondary batteries may be used as power sources for driving motors in hybrid electric vehicles, electric vehicles, and other vehicles, power storage batteries, and the like. The secondary battery may include an electrode assembly composed of positive and negative electrodes, a case for accommodating the electrode assembly, an electrode tab connected to the electrode assembly, etc.

The above information disclosed in this Background section is provided for enhancement of understanding of the background of the present disclosure, and, therefore, it may contain information that does not constitute related (or prior) art.

### SUMMARY

An apparatus for manufacturing a secondary battery according to the present disclosure includes a cap jig that moves to be in contact with a cap assembly, a guide jig that moves to be in contact with one side of an electrode tab that electrically connects the cap assembly to an electrode assembly, and a roller jig that moves to be in contact with the other side of the electrode tab.

The electrode assembly may be disposed inside a case, and the electrode tab may pass through an opening of the case.

The electrode tab may extend in a direction parallel to a longitudinal direction of the case.

The cap assembly may move in contact with the cap jig, and the electrode tab may be bent.

The cap assembly may be in contact with the cap jig to move toward the guide jig.

The electrode tab may include an electrode tab one side surface in contact with the guide jig, and an electrode tab other side surface in contact with the roller jig.

The guide jig may move in a direction in which the roller jig is disposed and may be in contact with the electrode tab one side surface to bend the electrode tab.

The guide jig may move parallel to a direction perpendicular to a longitudinal direction of the case.

The roller jig may move toward the guide jig and may be in contact with the electrode tab other side surface to bend the electrode tab.

The roller jig may be in contact with the electrode tab disposed between the guide jig and the cap assembly.

An angle formed by a direction perpendicular to a longitudinal direction of a case and a longitudinal direction of the roller jig may be maintained within 20 degrees.

The cap jig may include a cap jig body, and a cap jig body contact portion disposed on the cap jig body, formed in a curved shape, and in contact with the cap assembly.

The guide jig may include a guide jig body, and a guide jig body contact portion disposed on the guide jig body, formed in a curved shape, and in contact with the electrode tab.

The roller jig may include a roller jig body, and a roller jig body contact portion that is disposed on the roller jig body and rotates in contact with the electrode tab.

A method of manufacturing a secondary battery according to the present disclosure includes a cap jig contacting operation of bringing a cap assembly connected to an electrode tab into contact with a cap jig to bend the electrode tab, a guide jig contacting operation of bringing one side of the electrode tab connected to an electrode assembly into contact with a guide jig to bend the electrode tab, and a roller jig contacting operation of bringing the other side of the electrode tab into contact with a roller jig.

In the roller jig contacting operation, the roller jig may be in contact with the electrode tab disposed between the cap assembly and the guide jig.

The manufacturing method may further include a bending position changing operation of changing a position of the electrode tab bent in contact with the guide jig.

The manufacturing method may further include a jig contact releasing operation of separating the cap jig from the cap assembly and separating the guide jig and the roller jig from the electrode tab.

### BRIEF DESCRIPTION OF THE DRAWINGS

Features will become apparent to those of skill in the art by describing in detail exemplary embodiments with reference to the attached drawings, in which:

FIG. 1 is a perspective view illustrating a secondary battery according to an embodiment of the present disclosure;

FIG. 2 is a cross-sectional view illustrating a secondary battery according to an embodiment of the present disclosure;

FIG. 3 schematically illustrates an apparatus for manufacturing a secondary battery and the secondary battery according to an embodiment of the present disclosure;

FIG. 4 is a perspective view illustrating a cap jig of the apparatus for manufacturing a secondary battery according to an embodiment of the present disclosure;

FIG. 5 is a perspective view illustrating a guide jig of the apparatus for manufacturing a secondary battery according to an embodiment of the present disclosure;

FIG. 6 is a perspective view illustrating a roller jig according to an embodiment of the present disclosure;

FIG. 7 schematically illustrates contact between the cap jig and a cap assembly of the apparatus for manufacturing a secondary battery according to an embodiment of the present disclosure;

FIG. 8 schematically illustrates contact between the guide jig and a first electrode tab of the apparatus for manufacturing a secondary battery according to an embodiment of the present disclosure;

FIG. 9 schematically illustrates contact between the roller jig and the first electrode tab of the apparatus for manufacturing a secondary battery according to an embodiment of the present disclosure;

FIG. 10 schematically illustrates the first electrode tab of the secondary battery deformed by the apparatus for manufacturing a secondary battery according to an embodiment of the present disclosure;

FIG. 11 schematically illustrates the cap jig, the guide jig, and the roller jig of the apparatus for manufacturing a secondary battery according to an embodiment of the present disclosure, which are separated from the secondary battery; and

FIG. 12 is a flowchart illustrating a method of manufacturing a secondary battery according to an embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” “linked to.” or “coupled to” another element or layer, it may be directly on, connected, linked, or coupled to the other element or layer or one or more intervening elements or layers may also be present. When an element or layer is referred to as being “directly on,” “directly connected to,” “directly linked to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will also be understood that when an element is referred to as being “between” two elements, it can be the only element between the two elements, or one or more intervening elements may also be present.

In the figures, dimensions of the various elements, layers, etc. may be exaggerated for clarity of illustration. The same reference numerals designate the same or like elements throughout. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, when a part is referred to as being “electrically coupled” to another part, the part may be directly electrically connected to another part or one or more intervening parts may be present therebetween such that the part and the other part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

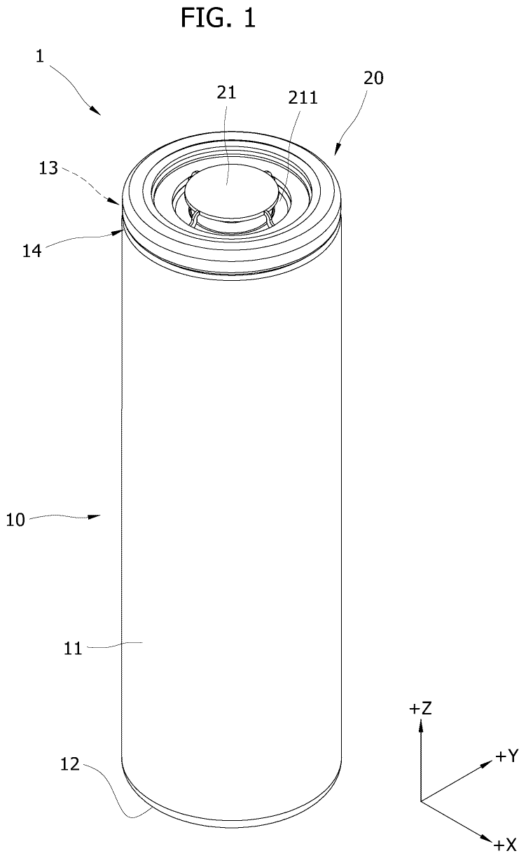

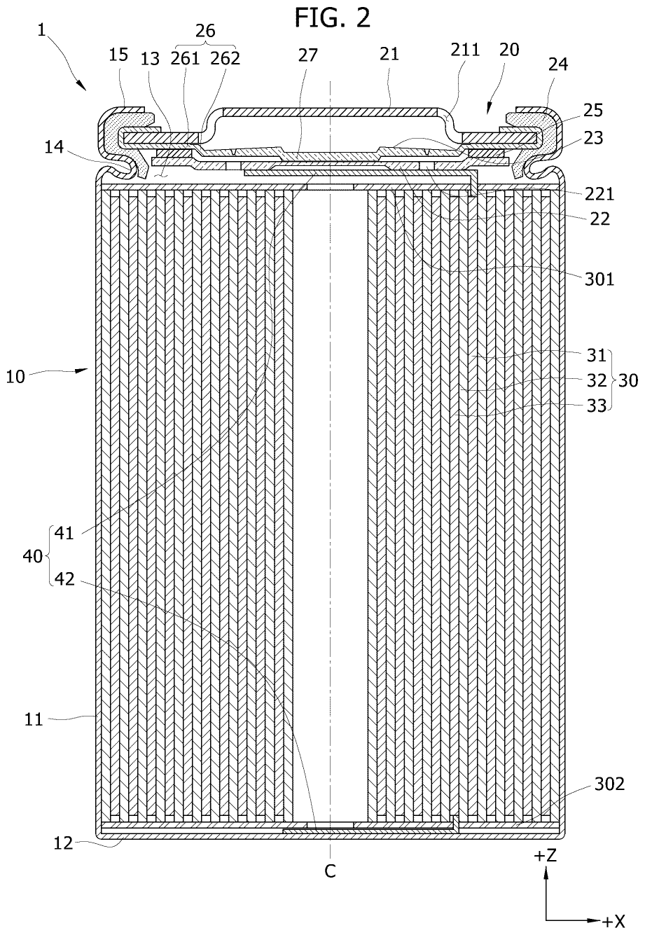

FIG. 1 is a perspective view illustrating a secondary battery according to an embodiment of the present disclosure, and FIG. 2 is a cross-sectional view of the secondary battery in FIG. 1.

Referring to FIGS. 1 and 2, a secondary battery 1 according to the present embodiment may include a case 10, a cap assembly 20, an electrode assembly 30, and an electrode tab 40.

Hereinafter, an example in which the secondary battery 1 is a cylindrical battery as a lithium ion secondary battery will be described. However, the secondary battery according to example embodiments may be a lithium polymer battery or a prismatic battery.

The case 10 may form an approximate appearance of the secondary battery 1. The case 10 may be provided to be electrically conductive. For example, the case 10 may include at least one material of steel, stainless steel, aluminum, and an aluminum alloy. Therefore, the case 10 may protect the electrode assembly 30 from an external impact and perform a heat dissipation function of externally dissipating heat generated by charging and discharging operations of the electrode assembly 30.

The case 10 according to the present embodiment may include a cylindrical sidewall part 11 having a center axis C formed at a central portion thereof. The center axis C of the case 10 described below may be a center axis of the sidewall part 11. Both ends of the sidewall part 11 perpendicular to the center axis C of the case 10 may be formed to be open. According to an embodiment, the top (e.g., in a +Z-axis direction) of the sidewall part 11 may be formed to be open.

The case 10 may further include a bottom part 12 (e.g., in a −Z-axis direction) that closes a lower end portion of the sidewall part 11. The bottom part 12 according to the present embodiment may be formed to have a substantially disc shape. The bottom part 12 may be disposed perpendicular to the center axis C of the case 10. A circumferential surface of the bottom part 12 may be coupled to the lower end portion of the sidewall part 11. The bottom part 12 may be formed integrally with the sidewall part 11 by a drawing process, etc. or alternatively, may be manufactured separately from the sidewall part 11 and then bonded to the sidewall part 11 by welding, etc.

The case 10 may further include an opening 13 that opens an upper end portion (e.g., in the +Z-axis direction) of the sidewall part 11. The opening 13 may function as a component that provides a path in which the electrode assembly 30 described below is inserted into the case 10 in an upper end area of the case 10 and provides a space in which the cap assembly 20 described below may be installed. The opening 13 according to the present embodiment may be an empty space surrounded by an upper end area of the sidewall part 11 positioned at a side opposite to the bottom part 12.

The electrode assembly 30 may function as a unit structure that performs charging and discharging operations of power in the secondary battery 1. The electrode assembly 30 may include a first electrode plate 31, a second electrode plate 32, and a separator 33 disposed between the first electrode plate 31 and the second electrode plate 32.

The electrode assembly 30 may be disposed inside the case 10. The electrode assembly 30 may be inserted into the case 10 through the opening 13 of the case 10.

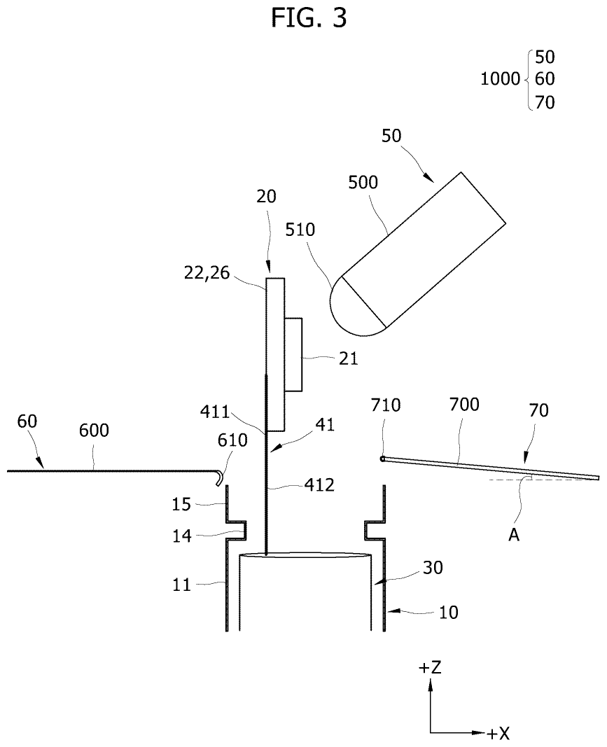

The electrode tab 40 may electrically connect the electrode assembly 30 to the case 10 and the cap assembly 20. The electrode tab 40 may include a first electrode tab 41 and a second electrode tab 42. The electrode tab 40 will be described in detail below together with the description of FIGS. 3 to 7.

The electrode assembly 30 may have a form wound around a winding axis. More specifically, the electrode assembly 30 may have a form wound clockwise or counterclockwise around the winding axis in a state in which the first electrode plate 31, the separator 33, and the second electrode plate 32 are stacked. Therefore, the electrode assembly 30 may have a substantially jelly roll shape. A cross-sectional shape of the electrode assembly 30 may be changed in terms of design to have various shapes such as an oval or polygonal shape in addition to a circular shape. Here, the winding axis may be a straight line that passes through the central portion of the electrode assembly 30. The winding axis of the electrode assembly 30 may be disposed to be coaxial with the center axis C of the case 10.

The first electrode plate 31 may function as a positive electrode of the electrode assembly 30. The first electrode plate 31 may be formed to have a form of a foil including a metallic material such as aluminum or an aluminum alloy. The type, size, shape, etc. of the first electrode plate 31 may be varied as long as the first electrode plate 31 has conductivity without causing a chemical change in the secondary battery.

At least a part of the first electrode plate 31 may be coated with a first active material layer. Both surfaces of the first electrode plate 31 may be coated with the first active material layer or alternatively, only one surface of the first electrode plate 31 may be coated with the first active material layer.

Since the first electrode plate 31 functions as a positive electrode, the first active material layer may include a positive electrode active material.

The positive electrode active material may be a compound capable of reversible intercalation and deintercalation of lithium (a lithiated intercalation compound). More specifically, as the positive electrode active material, one or more of composite oxides of a metal selected from cobalt, manganese, nickel, iron, and a combination thereof and lithium may be used.

As an example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM). Here, 0<x<1, 0<y<1, 0<z<1, and x+y+z=1 may be satisfied. The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM) and include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM).

The first active material layer may further include a positive electrode conductive material.

The positive electrode conductive material is used to impart conductivity to the first active material layer, and any material that is an electrically conductive material without causing a chemical change may be used. An example of the positive electrode conductive material may include carbon materials such as natural graphite, artificial graphite, carbon black, acetylene black, Ketjen black, carbon fibers, carbon nanofibers, and carbon nanotubes, a metal material in the form of metal powder or metal fibers containing copper, nickel, aluminum, silver, etc., a conductive polymer such as a polyphenylene derivative, or a mixture thereof.

The first active material layer may further include a positive electrode binder.

The positive electrode binder functions to attach particles constituting the positive electrode active material well and also functions to attach the positive electrode active material to the first electrode plate 31 well.

An example of the positive electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the positive electrode binder, the aqueous binder may further include a cellulose series compound capable of imparting viscosity. As the cellulose series compound, one or more of carboxymethyl cellulose, hydroxypropylmethyl cellulose, methyl cellulose, or an alkali metal salt thereof may be used in combination. The alkali metal may include Na, K, or Li.

The dry binder may be a polymer material which may be fiberized, for example, polytetrafluoroethylene, polyvinylidene fluoride, a polyvinylidene fluoride-hexafluoropropylene copolymer, polyethylene oxide, or a combination thereof.

The first electrode plate 31 may be electrically connected to the cap assembly 20 described below. As the first electrode plate 31 functions as a positive electrode of the electrode assembly 30, the cap assembly 20 may function as a positive electrode terminal of the secondary battery 1. For example, the first electrode plate 31 may be electrically connected to the cap assembly 20 by the first electrode tab 41. The first electrode tab 41 according to the present embodiment may include a conductive metallic material such as copper, a copper alloy, nickel, or a nickel alloy. The first electrode tab 41 may be disposed at the top (e.g., in the +Z-axis direction) of the electrode assembly 30, and both end portions of the first electrode tab 41 may each be connected to the first electrode plate 31 and the cap assembly 20. One end portion of the first electrode tab 41 may be directly connected to the first electrode plate 31 and may also be indirectly connected to the first electrode plate 31 via a separate collection plate connected to the first electrode plate 31.

The second electrode plate 32 may function as a negative electrode of the electrode assembly 30. The second electrode plate 32 may be formed to have a form of a foil including a metallic material such as copper, a copper alloy, nickel, or a nickel alloy. The second electrode plate 32 may be disposed to face the first electrode plate 31 at a predetermined distance. The type, size, shape, etc. of the second electrode plate 32 may be varied as long as the second electrode plate 32 has conductivity without causing a chemical change in the secondary battery.

At least a part of the second electrode plate 32 may be coated with a second active material layer. Both surfaces of the second electrode plate 32 may be coated with the second active material layer or alternatively, only one surface of the second electrode plate 32 may be coated with the second active material layer.

Since the second electrode plate 32 functions as a negative electrode, the second active material layer may include a negative electrode active material.

The negative electrode active material may include a material capable of reversible intercalation/deintercalation of lithium ions, a lithium metal, a lithium metal alloy, a material capable of doping and dedoping lithium, or a transition metal oxide.

The material capable of reversibly intercalating/deintercalating lithium ions may be a carbon negative electrode active material, which may include, for example, crystalline carbon, amorphous carbon, or a combination thereof. An example of the crystalline carbon may include graphite such as amorphous, plate-like, flaky, spherical, or fibrous natural graphite or artificial graphite, and examples of the amorphous carbon may include soft carbon, hard carbon, mesophase pitch carbide, calcined coke, etc.

As the lithium metal alloy, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si negative electrode active material or a Sn negative electrode active material may be used. The Si negative electrode active material may be silicon, a silicon-carbon composite, SiOₓ (x=1 or 2), a Si-Q alloy (Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn negative electrode active material may be Sn, SnO₂, a Sn alloy, or a combination thereof.

The silicon-carbon composite may be a composite of silicon and amorphous carbon. According to an embodiment, the silicon-carbon composite may be in the form of silicon particles whose surfaces are coated with amorphous carbon. For example, the silicon-carbon composite may include a secondary particle (core) in which primary silicon particles are aggregated and an amorphous carbon coating layer (shell) located on a surface of the secondary particle. The amorphous carbon may be positioned between the primary silicon particles, for example, so that the primary silicon particles may be coated with amorphous carbon. The secondary particles may be present by being dispersed in an amorphous carbon matrix.

The silicon-carbon composite may further include crystalline carbon. For example, the silicon-carbon composite may include a core including crystalline carbon and silicon particles and an amorphous carbon coating layer positioned on the surface of the core.

The Si negative electrode active material or Sn negative electrode active material may be used in combination with a carbon negative electrode active material.

The second active material layer may further include a negative electrode conductive material and a negative electrode binder.

The negative electrode conductive material is used to impart conductivity to the second active material layer, and any material that is an electrically conductive material without causing a chemical change may be used. An example of the negative electrode conductive material may include carbon materials such as natural graphite, artificial graphite, carbon black, acetylene black, Ketjen black, carbon fibers, carbon nanofibers, and carbon nanotubes, a metal material in the form of metal powder or metal fibers containing copper, nickel, aluminum, silver, etc., a conductive polymer such as a polyphenylene derivative, or a mixture thereof.

The negative electrode binder functions to attach particles constituting the negative electrode active material well and also functions to attach the negative electrode active material to the second electrode plate 32 well.

An example of the negative electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the aqueous binder may further include a cellulose series compound capable of imparting viscosity. As the cellulose series compound, one or more of carboxymethyl cellulose, hydroxypropylmethyl cellulose, methyl cellulose, or an alkali metal salt thereof may be used by being mixed. The alkali metal may include Na, K, or Li.

The dry binder may be a polymer material which may be fiberized, for example, polytetrafluoroethylene, polyvinylidene fluoride, polyvinylidene a fluoride-hexafluoropropylene copolymer, polyethylene oxide, or a combination thereof.

The second electrode plate 32 may be electrically connected to the case 10. For example, the second electrode plate 32 may be electrically connected to the case 10 by the second electrode tab 42. As the second electrode plate 32 functions as a negative electrode of the electrode assembly 30, the case 10 may function as a negative electrode terminal of the secondary battery 1. The second electrode tab 42 according to the present embodiment may include a conductive metallic material such as copper, a copper alloy, nickel, or a nickel alloy. The second electrode tab 42 may be disposed at a lower side of the electrode assembly 30, and both end portions thereof may each be connected to the second electrode plate 32 and the bottom part 12 of the case 10. One end portion of the second electrode tab 42 may be directly connected to the second electrode plate 32 and may also be indirectly connected to the second electrode plate 32 via a separate collection plate connected to the second electrode plate 32.

The separator 33 may be disposed between the first electrode plate 31 and the second electrode plate 32. The separator 33 may perform a function of preventing a short circuit between the first electrode plate 31 and the second electrode plate 32 while allowing the movement of lithium ions between the first electrode plate 31 and the second electrode plate 32.

As the separator 33, polyethylene, polypropylene, polyvinylidene fluoride, or a multilayer film of two or more layers thereof may be used, and a mixed multilayer film such as a polyethylene/polypropylene two-layer separator, a polyethylene/polypropylene/polyethylene three-layer separator, a polypropylene/polyethylene/polypropylene three-layer separator, or the like may be used.

The separator 33 may include a porous substrate and a coating layer including an organic material, an inorganic material, or a combination thereof, which is positioned on one surface or both surfaces of the porous substrate.

The porous substrate may be a polymer film made of one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fibers, and polytetrafluoroethylene (e.g.,. Teflon), or a copolymer or mixture of two or more of the above materials.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be present by being mixed in one coating layer or may be present by stacking a coating layer containing an organic material and a coating layer containing an inorganic material.

The separator 33 may be provided as a pair of separators. The pair of separators 33 may each be disposed to face one of both surfaces of the first electrode plate 31 or the second electrode plate 32. The pair of separators 33 may be wound around the winding axis together with the first electrode plate 31 and the second electrode plate 32.

A first insulation plate 301 and a second insulation plate 302 may each be disposed at one of both sides of the electrode assembly 30. The first insulation plate 301 and the second insulation plate 302 may include an insulating material such as rubber, polyethylene (PE), polypropylene (PP), polyethylene terephthalate (PET), etc.

The first insulation plate 301 according to the present embodiment may be formed to have a substantially disc shape. The first insulation plate 301 may be disposed between an upper surface of the electrode assembly 30 and the cap assembly 20. Therefore, the first insulation plate 301 can block the upper surface of the electrode assembly 30 from being in direct contact with the cap assembly 20 and mutually insulate the electrode assembly 30 and the cap assembly 20. A through hole through which the first electrode tab 41 may pass may be formed in the first insulation plate 301.

The second insulation plate 302 according to the present embodiment may be formed to have a substantially disc shape. The second insulation plate 302 may be disposed between a lower surface of the electrode assembly 30 and the bottom part 12 of the case 10. Therefore, the second insulation plate 302 can block the lower surface of the electrode assembly 30 from being in direct contact with the bottom part 12 of the case 10 and mutually insulate the electrode assembly 30 and the bottom part 12 of the case 10. A through hole through which the second electrode tab 42 may pass may be formed in the second insulation plate 302.

The cap assembly 20 may be coupled to the case 10 and may seal the opening 13 of the case 10.

For example, the cap assembly 20 may be disposed on the upper end portion of the sidewall part 11, i.e., the opening 13. A beading part 14 concavely formed toward the center axis C of the case 10 may be formed on the sidewall part 11. The beading part 14 may be disposed at the lower side of the cap assembly 20 to restrict the cap assembly 20 from being inserted into the case 10 to a set distance or more. A crimping part 15 in which the upper end portion of the sidewall part 11 is bent toward the center axis C of the case 10 may be formed at the top of the beading part 14. The crimping part 15 may be disposed at the top of the cap assembly 20, thereby preventing the cap assembly 20 from being separated to the outside of the case 10.

A gasket 24 may be disposed between the case 10 and the cap assembly 20. The gasket 24 may function as a component that fixes the cap assembly 20 to the opening 13 by its elastic restoring force, electrically mutually insulates the case 10 and the cap assembly 20, and blocks moisture or an electrolyte from being introduced or discharged between the case 10 and the cap assembly 20.

The gasket 24 according to the present embodiment may include an insulating material such as rubber, polyethylene (PE), polypropylene (PP), polyethylene terephthalate (PET), etc. The gasket 24 may be formed to have a substantially ring shape and disposed inside the beading part 14 and/or the crimping part 15. An outer surface of the gasket 24 may be in close contact with inner surfaces of the beading part 14 and/or the crimping part 15, and an inner surface of the gasket 24 may be in close contact with an outer surface of the cap assembly 20.

The cap assembly 20 may be electrically connected to the first electrode plate 31 by the first electrode tab 41. As the first electrode plate 31 functions as the positive electrode of the electrode assembly 30, the cap assembly 20 may function as the positive electrode terminal of the secondary battery.

The cap assembly 20 may block the electrical connection between the secondary battery 1 and an external device when an internal pressure of the case 10 increases due to an overcurrent, etc. The cap assembly 20 may rupture when the internal pressure of the case 10 increases to a set value or more and connect an internal space of the case 10 to an external space of the case 10. Therefore, the cap assembly 20 can reduce the risk of explosion of the secondary battery 1 when an overcurrent is generated.

The cap assembly 20 may include a cap up 21, a cap down 22, a vent plate 23, an extension 26, and a contact part 27.

The cap up 21 may form an upper exterior of the cap assembly 20 and may be disposed in the opening 13. The cap up 21 may be electrically connected to the first electrode plate 31 by the cap down 22 and the vent plate 23, which will be described below.

The cap up 21 according to the present embodiment may have a disc shape in which a central portion protrudes to be convex upward. A center axis of the cap up 21 may be positioned coaxially with the center axis C of the case 10. A central portion of the cap up 21 may protrude outward from the case 10. An edge portion of the cap up 21 may be disposed inside the case 10. A perimetric surface of the edge portion of the cap up 21 may be spaced a predetermined interval from the inner surface of the gasket 24. The cap up 21 may be formed of an electrically conductive material such as nickel, aluminum, or copper.

A cap up hole 211 for discharging gas, etc. generated inside the case 10 to the outside of the case 10 may be formed in the cap up 21. The cap up hole 211 according to the present embodiment may have a form of a hole that passes through a perimetric surface of the central portion of the cap up 21. The cap up hole 211 may be provided as a plurality of cap up holes. The plurality of cap up holes 211 may be arranged at predetermined intervals along the perimetric surface of the central portion of the cap up 21.

The cap down 22 may be disposed to face the cap up 21 and electrically connected to the electrode assembly 30. The cap down 22 according to the present embodiment may be formed to have a substantially disc shape and disposed inside the case 10. The cap down 22 may be disposed under the cap up 21. That is, the cap down 22 may be disposed between the cap up 21 and the electrode assembly 30. A center axis of the cap down 22 may be disposed coaxially with the center axis C of the case 10. An upper surface of the cap down 22 may be disposed to be spaced apart from a lower surface of the cap up 21.

An area of the cap down 22 may be smaller than a cross-sectional area of the electrode assembly 30 perpendicular to the center axis C of the case 10. However, the area of the cap down 22 may also be equal to or greater than the cross-sectional area of the electrode assembly 30.

The cap down 22 may be formed of an electrically conductive material such as nickel, aluminum, or copper. The cap down 22 may be electrically connected to the electrode assembly 30. For example, an end portion of the first electrode tab 41 extending from the first electrode plate 31 may be connected to a bottom surface of the cap down 22 by any of various types of coupling methods such as welding. The cap down 22 may be electrically connected to the cap up 21 by the vent plate 23 described below.

A cap down hole 221 that vertically passes through the cap down 22 may be formed in the cap down 22. The cap down hole 221 may function as a component that provides a path for gas, etc. generated inside the case 10 to pass through the cap down 22 when an overcurrent is generated. The cap down hole 221 may be provided as a plurality of cap down holes. The plurality of cap down holes 221 may be arranged along the perimetric surface of the center axis of the cap down 22.

The vent plate 23 may be disposed between the cap up 21 and the cap down 22. The vent plate 23 may provide an electrical conduction path of a current between the cap up 21 and the cap down 22 when the secondary battery 1 normally operates. The vent plate 23 may be deformed in shape by a pressure of the gas generated inside the case 10 when an overcurrent is generated and can block electrical connection of the cap up 21 and the cap down 22. The vent plate 23 may rupture when the internal pressure of the case 10 increases to a set value or more and open a gas discharge path between the cap up hole 211 and the cap down hole 221.

The vent plate 23 according to the present embodiment may be formed to have a substantially disc shape. Upper and lower surfaces of the vent plate 23 may be disposed to face the cap up 21 and the cap down 22, respectively. The lower surface of the vent plate 23 may be disposed to face the cap down hole 221. A center axis of the vent plate 23 may be disposed coaxially with the center axis C of the case 10. The vent plate 23 may be formed of an electrically conductive material such as nickel, aluminum, copper, etc.

A cap insulator 25 may be disposed between the vent plate 23 and the cap down 22. The cap insulator 25 may function as a component that prevents direct contact between the vent plate 23 and the cap down 22 and guides the vent plate 23 and the cap down 22 to be electrically connected by only the contact part 27 described below.

The cap insulator 25 according to the present embodiment may be formed to have a hollow ring shape. A center axis of the cap insulator 25 may be positioned coaxially with the center axis C of the case 10 and the center axis of the vent plate 23. An upper surface of the cap insulator 25 may be in contact with the lower surface of the vent plate 23, and a lower surface of the cap insulator 25 may be in contact with the upper surface of the cap down 22. The cap insulator 25 may be formed of an insulating material such as polyethylene (PE), polypropylene (PP), polyethylene terephthalate (PET), etc.

The extension 26 may extend from the vent plate 23 and may be connected to the cap up 21. The extension 26 may function as a component that supports the vent plate 23 with respect to the cap up 21 and provides electrical connection between the cap up 21 and the vent plate 23. The extension 26 may be formed of the same material as the vent plate 23. The extension 26 according to the present embodiment may include a support 261 and a hinge 262.

The support 261 may form the exterior of one side of the extension 26 and may be connected to the cap up 21. The support 261 according to the present embodiment may be disposed to surround an end portion of the cap up 21, i.e., an edge area of the cap up 21 that faces the gasket 24. For example, the support 261 may have a cross-sectional shape that is substantially U-shaped. One end portion of the support 261 may be in contact with an upper surface of the cap up 21, and the other end portion of the support 261 may be bent downward to be in contact with the lower surface of the cap up 21. The support 261 may be coupled to the cap up 21 by any of various types of coupling methods such as laser welding, ultrasonic welding, or resistance welding.

The hinge 262 may form the exterior of the other side of the extension 26 and may be disposed between the support 261 and the vent plate 23. The hinge 262 may function as a component that interconnects the support 261 and the vent plate 23 and guides deformation of the vent plate 23 when the internal pressure of the case 10 increases.

The hinge 262 according to the present embodiment may have a substantially disc shape and may be disposed between the support 261 and the vent plate 23. An inner perimetric surface of the hinge 262 may be connected to the vent plate 23, and an outer perimetric surface of the hinge 262 may be connected to the other end portion of the support 261. The hinge 262 may extend to be stepped downward from the outer perimetric surface to the inner perimetric surface. For example, a central portion of the hinge 262 may have a cross-section bent in an L shape. A bent angle of the central portion of the hinge 262 may be changed in terms of design to have any of various angles in addition to the angle illustrated in FIG. 2.

When an overcurrent is generated, the vent plate 23 may be deformed with respect to the hinge 262. For example, when the internal pressure of the case 10 increases due to an overcurrent, the gas that has passed through the cap down hole 221 may press the vent plate 23 upward, and the vent plate 23 may be deformed into a shape in which the central portion protrudes to be convex upward due to a change in bent angle of the hinge 262.

The contact part 27 may protrude from the vent plate 23 to the cap down 22 and may be in contact with the cap down 22. The contact part 27 may function as a component that electrically connects the vent plate 23 to the cap down 22. Therefore, a current generated from the first electrode plate 31 may be transmitted to the cap up 21 sequentially through the first electrode tab 41, the cap down 22, the contact part 27, the vent plate 23, and the extension 26.

The contact part 27 according to the present embodiment may protrude downward from the lower surface of the vent plate 23. A lower surface of the contact part 27 may be in contact with the upper surface of the cap down 22. A center axis of the contact part 27 may be positioned coaxially with the center axis C of the case 10 and the center axis of the vent plate 23. A diameter of the contact part 27 may be changed in terms of design in any of various ways within a range smaller than an inner diameter of the cap insulator 25.

When the vent plate 23 is deformed due to an increase in internal pressure of the case 10, the contact part 27 may be separated from the cap down 22. Therefore, when an overcurrent is generated, electrical connection between the cap down 22 and the vent plate 23 may be blocked.

A thickness of a part of the vent plate 23 according to the present embodiment may increase toward the center axis C of the case 10. Here, the thickness of the vent plate 23 may be a vertical length of the vent plate 23 parallel to the center axis C of the case 10.

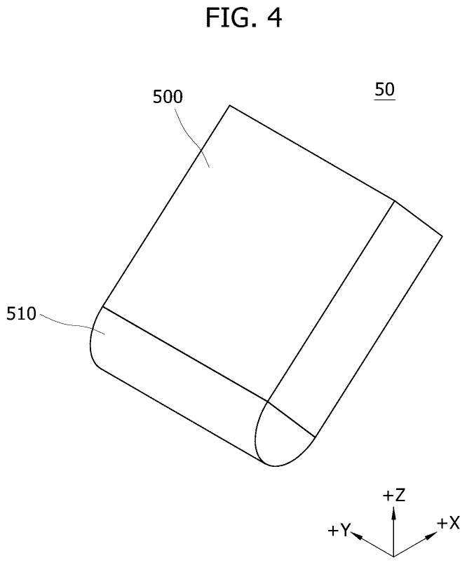

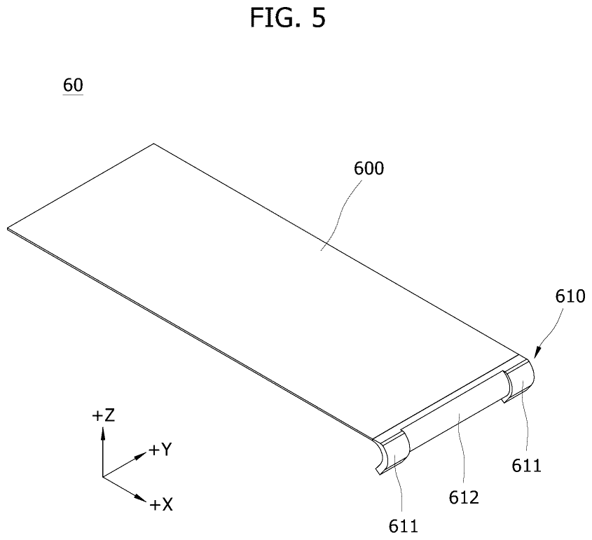

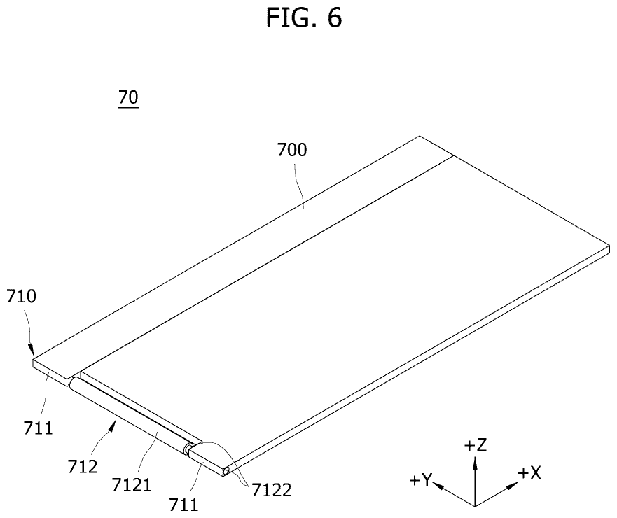

FIG. 3 schematically illustrates an apparatus for manufacturing a secondary battery according to an embodiment of the present disclosure, FIG. 4 is a perspective view illustrating a cap jig of the apparatus in FIG. 3, FIG. 5 is a perspective view illustrating a guide jig of the apparatus in FIG. 3, and FIG. 6 is a perspective view illustrating a roller jig of the apparatus in FIG. 3. An apparatus 1000 for manufacturing a secondary battery (e.g., the secondary battery 1 of FIGS. 1-2) will be described with reference to FIGS. 3 to 6.

Referring to FIG. 3, the apparatus 1000 for manufacturing a secondary battery may include a cap jig 50, a guide jig 60, and a roller jig 70. Hereinafter, the apparatus 1000 for manufacturing a secondary battery will be described generally. The apparatus 1000 for manufacturing a secondary battery may perform a process of arranging the cap assembly 20 on the secondary battery 1.

Referring to FIG. 3, the electrode assembly 30 may be disposed inside the case 10 of the secondary battery 1, and the electrode assembly 30 may be connected to the electrode tab 40. According to an embodiment, the electrode assembly 30 may be connected to the first electrode tab 41. The first electrode tab 41 may function as a positive electrode.

The first electrode tab 41 may be connected to the electrode assembly 30 and may extend in one direction (e.g., the first electrode tab 41 may extend lengthwise above the electrode assembly 30 and above the case 10 in the +Z-axis direction). The cap assembly 20 may be disposed on the end portion of the first electrode tab 41. The first electrode tab 41 may be bonded to the cap assembly 20. According to an embodiment, the first electrode tab 41 may be welded to the cap assembly 20.

A radial direction of the cap assembly 20 may be disposed parallel to an extension direction of the first electrode tab 41. Therefore, the radial direction of the cap assembly 20 may be disposed parallel to one direction (e.g., the Z-axis direction). The first electrode tab 41 may be bent by the cap jig 50, the guide jig 60, and the roller jig 70.

In detail, the cap jig 50 may contact the cap assembly 20 to move the cap assembly 20, and may bend the first electrode tab 41 connected to the cap assembly 20. According to an embodiment, the cap jig 50 may move in one direction (e.g., a −X-axis direction) to contact the cap assembly 20. The cap jig 50 may contact the cap assembly 20 so that the cap assembly 20 may rotate (e.g., counterclockwise). As the cap assembly 20 rotates (e.g., bends), the first electrode tab 41 connected to the cap assembly 20 may be bent together with the cap assembly 20 toward the guide jig 60.

The guide jig 60 may be disposed at one side (e.g., in the −X-axis direction) of the first electrode tab 41. The guide jig 60 may move in one direction (e.g., the X-axis direction) to contact the first electrode tab 41.

As the guide jig 60 is in contact with an electrode tab on one side surface 411 of the first electrode tab 41, the first electrode tab 41 may be bent. As the guide jig 60 is in contact with the electrode tab one side surface 411, the first electrode tab 41 may be bent to be formed convexly in one direction (e.g., the +X-axis direction).

The roller jig 70 may be disposed at the other side (e.g., in the +X-axis direction) of the first electrode tab 41. The roller jig 70 may move in one direction (e.g., the X-axis direction) to be in contact with the first electrode tab 41.

As the roller jig 70 is in contact with an electrode tab other side surface 412 of the first electrode tab 41, the first electrode tab 41 may be bent. The roller jig 70 may contact the first electrode tab 41 disposed between the guide jig 60 and the cap assembly 20. According to an embodiment, a position of the electrode tab other side surface 412 in contact with the roller jig 70 may be disposed higher (e.g., in the +Z-axis direction) than a position of the electrode tab one side surface 411 in contact with the guide jig 60 (FG. 9). Therefore, the first electrode tab 41 may be disposed between the guide jig 60 and the roller jig 70.

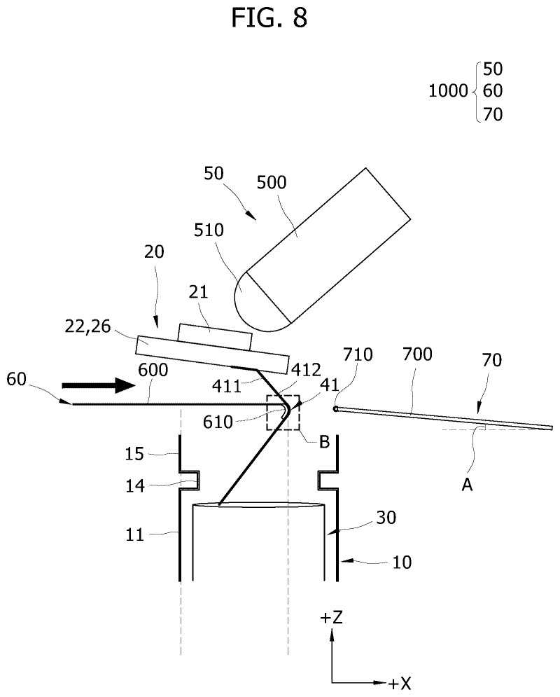

The cap assembly 20 may be moved by the cap jig 50 so that the first electrode tab 41 is bent, and in a state in which the first electrode tab 41 is bent by the guide jig 60 and the roller jig 70, the case 10 moves downward (e.g., in the −Z-axis direction) or the cap jig 50, the guide jig 60, and the roller jig 70 move upward (e.g., in the +Z-axis direction) so that a bending position B at which the first electrode tab 41 is bent is moved (FIG. 8). According to an embodiment, the bending position B at which the first electrode tab 41 is bent may be closer to the cap assembly 20.

Hereinafter, a specific configuration of the apparatus 1000 for manufacturing a secondary battery will be described.

Referring to FIG. 4, the cap jig 50 is illustrated. The cap jig 50 may include a cap jig body 500 and a cap jig body contact portion 510.

A shape of the cap jig body 500 may be provided as a substantially plate shape. The cap jig body contact portion 510 may be disposed on the cap jig body 500. The cap jig body contact portion 510 may be disposed at one side (e.g., in the −X-axis direction) of the cap jig body 500. The cap jig body contact portion 510 may be provided in a curved shape, e.g., the cap jig body contact portion 510 may be an outer curved surface at a side of the cap jig body 500 that faces a region between the guide jig 60 and the roller jig 70. According to an embodiment, a shape of the cap jig body contact portion 510 may be provided as a substantially arc shape. A curvature of the cap jig body contact portion 510 may vary.

As illustrated in FIG. 3, the cap jig body 500 may be disposed to be tilted in one direction (e.g., between the −X-axis direction and the −Z-axis direction). According to an embodiment, the cap jig body 500 may be disposed to be tilted at about 20 degrees to about 70 degrees in the −Z-axis direction with respect to the −X-axis direction. The cap jig body 500 may be arranged to be tilted at about 45 degrees in the −Z-axis direction with respect to the −X-axis direction.

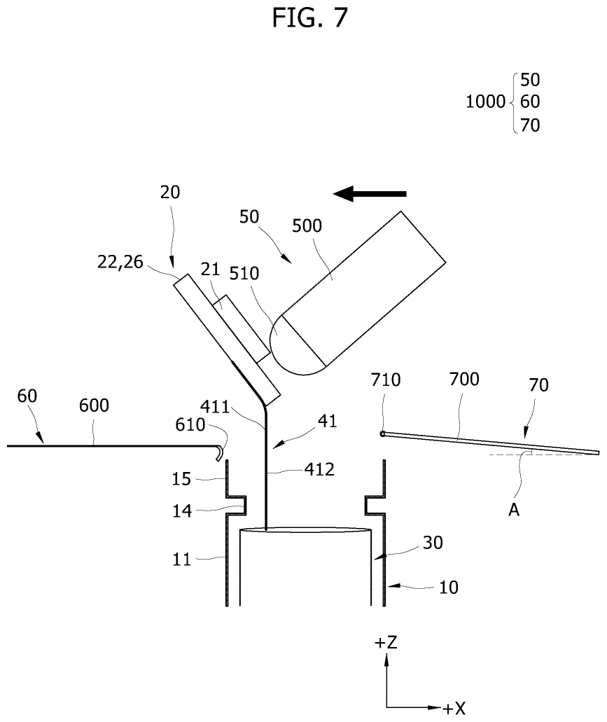

As the cap jig body 500 moves in one direction (e.g., the X-axis direction) toward the cap assembly 20 in a tilted state, the cap jig body contact portion 510 may be in contact with the cap assembly 20. As the cap jig body contact portion 510 is in contact with the cap assembly 20, the cap assembly 20 may rotate (FIG. 7). According to an embodiment, the cap assembly 20 may rotate counterclockwise (e.g., toward the guide jig 60). Therefore, the first electrode tab 41 electrically (e.g., and physically) connected to the cap assembly 20 may be bent (e.g., together with the ap assembly 20) to protrude in the +X-axis direction (FIG. 8).

According to an embodiment, the cap jig body 500 may move in the −X-axis direction so that the cap jig body contact portion 510 may be in contact with the cap assembly 20, and a portion in which the cap jig body contact portion 510 is in contact with the cap assembly 20 may vary.

Referring to FIG. 5, the guide jig 60 is illustrated. The guide jig 60 may include a guide jig body 600 and a guide jig body contact portion 610.

A shape of the guide jig body 600 may be provided as a substantially plate shape, e.g., the guide jig body 600 may extend in the X-axis direction. The guide jig body contact portion 610 may be disposed on the guide jig body 600. The guide jig body contact portion 610 may be disposed at one side (e.g., in the +X-axis direction) of the guide jig body 600, e.g., the guide jig body contact portion 610 may be at an edge of the guide jig body 600 that faces the roller jig 70.

A cross-sectional shape of the guide jig body contact portion 610 may be provided in a substantially ‘U’ shape. The guide jig body contact portion 610 may include guide protrusions 611 and a guide pad 612. The guide protrusions 611 may be disposed on both end portions of the guide jig body 600. The guide pad 612 may be disposed between the guide protrusions 611. The guide pad 612 may be in contact with the first electrode tab 41 (e.g., the guide pad 612 may be stationary and may accommodate positioning of the first electrode tab 41 between the guide protrusions 611). The guide pad 612 may be provided in the form of a groove that is more concave than the guide protrusion 611 (e.g., the guide protrusion 611 may protrude beyond the guide pad 612 in the +X-axis direction). A width of the guide pad 612 may be equal to or greater than a width of the first electrode tab 41 (e.g., in the Y-axis direction).

The first electrode tab 41 may be in contact with the guide pad 612 and may not be separated from the guide pad 612 by the guide protrusion 611. The first electrode tab 41 may be bent in contact with the guide pad 612 that is more concave than the guide protrusion 611.

The guide pad 612 may include any suitable material. According to an embodiment, the material of the guide pad 612 may include silicone and/or urethane. Since the material of the guide pad 612 includes silicone and/or urethane, appropriate friction may occur between the guide pad 612 and the first electrode tab 41 in contact with the guide pad 612.

Referring to FIG. 6, the roller jig 70 is illustrated. The roller jig 70 may include a roller jig body 700 and a roller jig body contact portion 710.

A shape of the roller jig body 700 may be provided as a substantially plate shape, e.g., the roller jig body 700 may extend in the X-axis direction. The roller jig body contact portion 710 may be disposed on the roller jig body 700. The roller jig body contact portion 710 may be disposed at one side (e.g., in the −X-axis direction) of the roller jig body 700, e.g., the roller jig body contact portion 710 may be at an edge of the roller jig body 700 that faces the guide jig 60. The roller jig body contact portion 710 may include roller protrusions 711 and a roller rotation portion 712.

The roller protrusions 711 may be disposed on both end portions of the roller jig body 700. The roller rotation portion 712 may be disposed between the roller protrusions 711, e.g., the roller rotation portion 712 may extend lengthwise in the Y-axis direction between the two roller protrusions 711. The roller rotation portion 712 may be rotated (e.g., rotatable) in contact with the first electrode tab 41.

The roller rotation portion 712 may include a roller rotation contact portion 7121 and a roller rotation center axis 7122. The roller rotation center axis 7122 may be disposed to be inserted into the roller protrusion 711 (e.g., the roller rotation center axis 7122 may be a linear member extending lengthwise between the two roller protrusions 711), and the roller rotation contact portion 7121 may rotate about the roller rotation center axis 7122. According to another embodiment, the roller rotation contact portion 7121 may rotate together with the roller rotation center axis 7122. The roller rotation contact portion 7121 may be in contact with the first electrode tab 41 and may rotate according to a movement of the first electrode tab 41 or a movement of the roller jig 70.

The roller rotation contact portion 7121 may be in contact with the first electrode tab 41. The roller rotation contact portion 7121 may be provided in the form of a roller. A width of the roller rotation contact portion 7121 may be equal to or greater than a width of the first electrode tab 41 (e.g., in the Y-axis direction). A curvature of the roller rotation contact portion 7121 may vary.

The roller rotation contact portion 7121 may include any suitable material. According to an embodiment, the material of the roller rotation contact portion 7121 may include silicone and/or urethane. Since the material of the roller rotation contact portion 7121 includes silicone and/or urethane, appropriate friction may occur between the roller rotation contact portion 7121 and the first electrode tab 41 in contact with the roller rotation contact portion 7121.

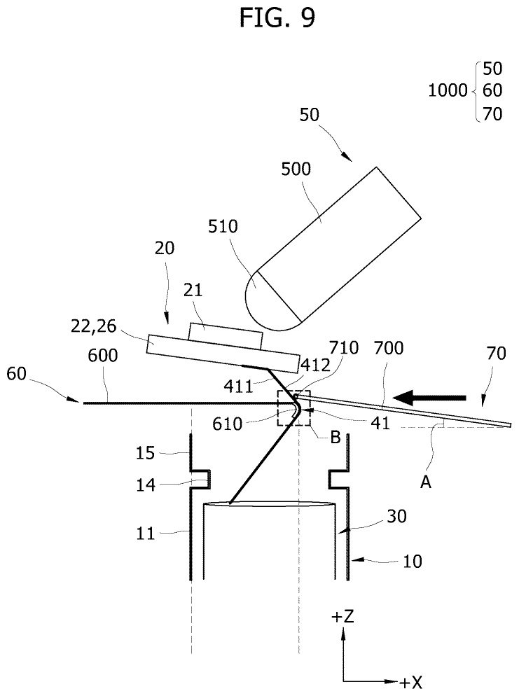

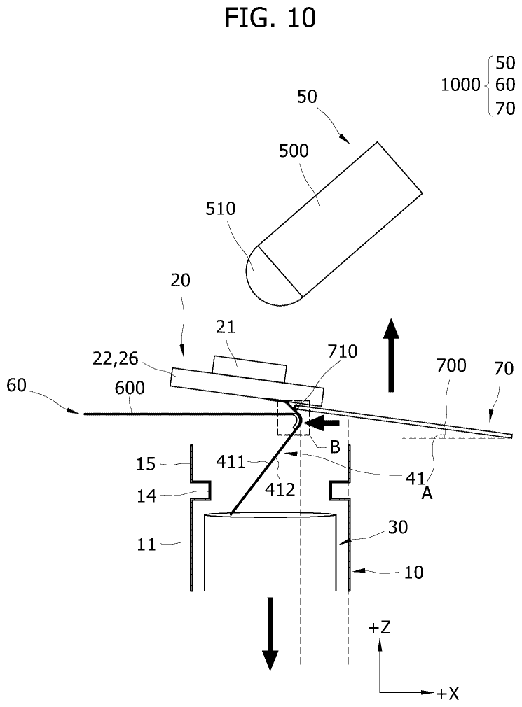

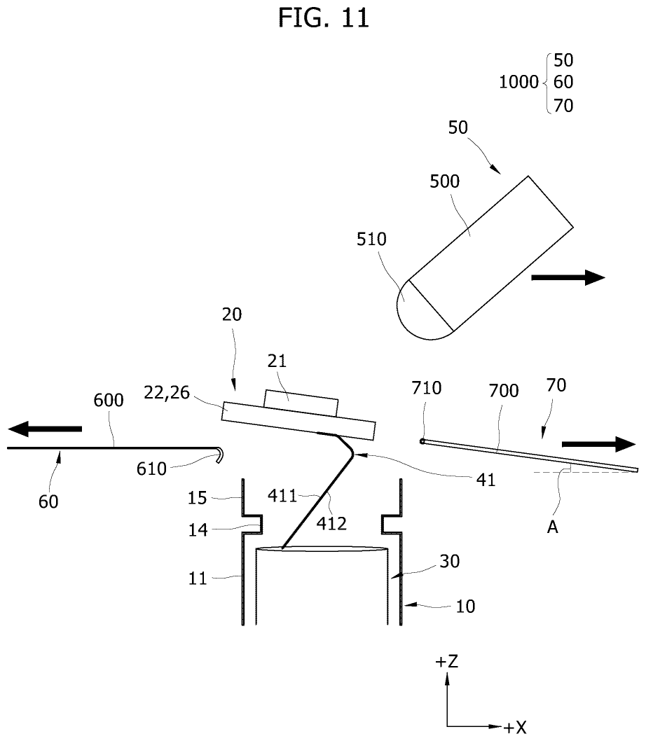

FIG. 7 schematically illustrates contact between the cap jig 50 and the cap assembly 20 of the apparatus 1000 for manufacturing a secondary battery according to an embodiment of the present disclosure, FIG. 8 schematically illustrates contact between the guide jig 60 and the first electrode tab 41 of the apparatus 1000 for manufacturing a secondary battery according to an embodiment of the present disclosure, FIG. 9 schematically illustrates contact between the roller jig 70 and the first electrode tab 41 of the apparatus 1000 for manufacturing a secondary battery according to an embodiment of the present disclosure, FIG. 10 schematically illustrates the first electrode tab 41 of the secondary battery deformed by the apparatus 1000 for manufacturing a secondary battery according to an embodiment of the present disclosure, and FIG. 11 schematically illustrates the cap jig 50, the guide jig 60, and the roller jig 70 of the apparatus 1000 for manufacturing a secondary battery according to an embodiment of the present disclosure, which are separated from the secondary battery.

The secondary battery 1, the case 10, the cap assembly 20, the electrode assembly 30, the first electrode tab 41, the electrode tab one side surface 411, the electrode tab other side surface 412, the apparatus 1000 for manufacturing a secondary battery, the cap jig 50, the guide jig 60, and the roller jig 70 illustrated in FIGS. 7 to 11 are the same as those illustrated in FIGS. 1 to 6. Therefore, description of the same component may be omitted. Stages in a process of bending the first electrode tab 41 through the apparatus 1000 for manufacturing a secondary battery will be described with reference to FIGS. 7 to 11.

Referring to FIG. 7, the cap jig 50 may be arranged above the guide jig 60 and the roller jig 70 in the +Z-axis direction, and may move in one direction (e.g., the −X-axis direction) to be in contact with the cap assembly 20. As the cap jig 50 is in contact with the cap assembly 20, the cap assembly 20 may rotate (e.g., bend), and the first electrode tab 41 may be bent (e.g., together with the cap assembly 20) toward the guide jig 60.

According to an embodiment, the cap jig body contact portion 510 of the cap jig 50 tilted between the −X-axis direction and the −Z-axis direction may be in contact with the cap up 21 of the cap assembly 20 to rotate the cap assembly 20 counterclockwise. According to an embodiment, the cap jig 50 may be disposed to be tilted at about 20 degrees to about 70 degrees in the −Z-axis direction with respect to the −X-axis direction. The cap jig 50 may be disposed to be tilted at about 45 degrees in the −Z-axis direction with respect to the −X-axis direction.

As the cap assembly 20 rotates counterclockwise, the first electrode tab 41 in contact with the cap assembly 20 may be formed to be convex in a direction (e.g., the +X-axis direction) in which the electrode tab other side surface 412 is disposed. The cap assembly 20 may be in contact with the cap jig body contact portion 510. The cap jig body contact portion 510 may be provided in a curved shape and may be in contact with the cap assembly 20 at various positions.

Referring to FIG. 8, it can be seen that the first electrode tab 41 is bent by the guide jig 60. In a state in which the first electrode tab 41 is bent to be convex in one direction (e.g., the +X-axis direction) by the cap jig 50, the guide jig 60 may move toward the roller jig 70 in one direction (e.g., the +X-axis direction) to be in contact with the first electrode tab 41 to bend the first electrode tab 41. For example, referring to FIG. 8, the cap jig 50 and the guide jig 60 may move in opposite directions (e.g., toward each other) to contact different portions of the first electrode tab 41 in order to bend the first electrode tab 41 at its contact point (i.e., the bending position B) with the guide jig 60.

According to an embodiment, the guide jig body contact portion 610 of the guide jig 60 may be in contact with the electrode tab one side surface 411 of the first electrode tab 41 to bend the first electrode tab 41 so that the first electrode tab 41 protrudes in one direction (e.g., in the +X-axis direction).

The guide jig 60 may move to about ⅔ points (from the end portion of the case 10 in the −X-axis direction and the end portion of the case 10 in the +X-axis direction) of the width (e.g., in the +X-axis direction) of the case 10. Therefore, the bending position B of the first electrode tab 41 may be disposed at about ⅔ points of the width of the case 10 (e.g., a distance of the bending position B from a left sidewall of the case 10 in FIG. 8 may be about ⅔ of a total with of the case 10 in the X-axis direction).

In this way, as the guide jig 60 moves to about ⅔ points of the width of the case 10 in one direction (e.g., +X-axis direction), the cap assembly 20 may further rotate counterclockwise. As the cap assembly 20 rotates counterclockwise, the contact between the cap assembly 20 and the cap jig 50 may be maintained. In addition, as the guide jig 60 moves to about ⅔ points of the width of the case 10 in one direction, the first electrode tab 41 may not be in contact with the case 10 even when the cap assembly 20 is disposed on the case 10.

Referring to FIG. 9, it can be seen that the roller jig 70 is in contact with the first electrode tab 41. The roller jig body contact portion 710 of the roller jig 70 may move toward the guide jig 60 to contact the first electrode tab 41 and to further bend the first electrode tab 41. A portion in which the roller jig 70 is in contact with the first electrode tab 41 may be disposed between the guide jig 60 and the cap assembly 20.

The roller jig 70 may be disposed to extend in one direction (e.g., between the −X-axis direction and the +Z-axis direction). An angle A between the direction in which the roller jig 70 extends and the −X-axis direction may be set to range from about 0 degrees to 30 degrees. According to an embodiment, the angle A may be set to range from about 5 degrees to 15 degrees. For example, referring to FIG. 9, the roller jig 70 may be disposed to extend at the angle A with respect to the guide jig 60 (e.g., so when the roller jig 70 moves toward the guide jig 60, an edge of the roller jig 70 may overhang a top of the guide jig 60 in the +Z-axis direction).

As the roller jig 70 moves in one direction (e.g., −X-axis direction), the roller jig body contact portion 710 may be in contact with the electrode tab other side surface 412 of the first electrode tab 41. A position at which the roller jig body contact portion 710 is in contact with the electrode tab other side surface 412 may be disposed at a position (e.g., in the +Z-axis direction) higher than a position at which the guide jig body contact portion 610 is in contact with the electrode tab one side surface 411 (e.g., relative to the case 10).

According to an embodiment, the roller jig 70 may move to about ⅗ points (from the end portion of the case 10 in the −X-axis direction to the end portion of the case 10 in the +X-axis direction) of the width of the case 10 while moving in one direction (−X-axis direction). In this way, as the roller jig 70 moves, a part of the guide jig 60 may be disposed closer to the +X-axis direction than the roller jig 70, and a part of the roller jig 70 may be disposed closer to the −X-axis direction than the guide jig 60. In other words, the roller jig 70 may vertically overlap a top of the guide jig 60 in the Z-axis direction, so a distance between an edge of the roller jig body contact portion 710 to the left sidewall of the case 10 (FIG. 9) may be smaller than a distance between an edge of the guide jig body contact portion 610 and the left sidewall of the case 10. Therefore, the electrode tab one side surface 411 and the electrode tab other side surface 412 of the first electrode tab 41 may be in (e.g., simultaneous) contact with the guide jig 60 and the roller jig 70, respectively, at the bending position B.

Referring to FIG. 10, it can be seen that the bending position B at which the first electrode tab 41 is in contact with the guide jig 60 and the roller jig 70 moves.

In a state in which the electrode tab one side surface 411 and the electrode tab other side surface 412 of the first electrode tab 41 are in contact with the guide jig 60 and the roller jig 70, respectively, at the bending position B, the case 10 may move downward (e.g., in the −Z-axis direction) or the cap jig 50, the guide jig 60, and the roller jig 70 may move upward (e.g., in the +Z-axis direction). As the case 10 moves downward or the apparatus 1000 for manufacturing a secondary battery moves upward, the bending position B, at which the first electrode tab 41 is bent, may move.

That is, according to an embodiment, the bending position B may move closer to the cap assembly 20. In addition, the bending position B may move in one direction (e.g., the −X-axis direction). As the bending position B moves, the abnormal bending phenomenon of the first electrode tab 41 can be prevented. Therefore, a defect rate of the secondary battery 1 can be reduced.

The case 10 may move downward or the apparatus 1000 for manufacturing a secondary battery may move upward to the extent that the guide jig 60 and/or the roller jig 70 are not in contact with the cap assembly 20.

Referring to FIG. 11, it can be seen that the cap jig 50, the guide jig 60, and the roller jig 70 may be released from contact with the cap assembly 20 and/or the first electrode tab 41. According to an embodiment, after the contact between the roller jig 70 and the first electrode tab 41 is released, the contact between the guide jig 60 and the first electrode tab 41 may be released, and then the cap jig 50 may be released from contact with the cap assembly 20.

According to an embodiment, the case 10 may move upward (e.g., in the +Z-axis direction) or the apparatus 1000 for manufacturing a secondary battery may move downward (e.g., in the −Z-axis direction) before the cap jig 50, the guide jig 60, and the roller jig 70 are released from contact with the cap assembly 20 and/or the first electrode tab 41.

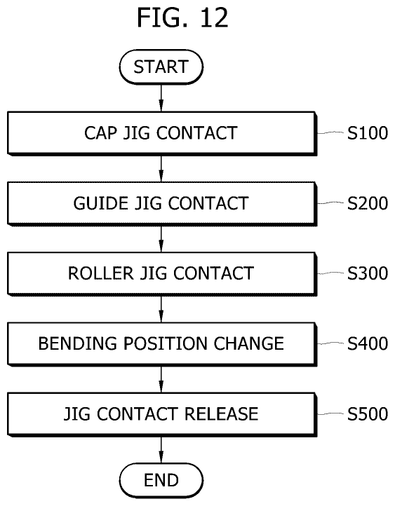

FIG. 12 is a flowchart illustrating a method of manufacturing a secondary battery according to an embodiment of the present disclosure.

Referring to FIG. 12, the method of manufacturing a secondary battery may include a cap jig contacting (S100) that brings the cap assembly 20 connected to the electrode tab 40 into contact with the cap jig 50 to bend the electrode tab 40, a guide jig contacting (S200) that brings one side of the electrode tab 40 connected to the electrode assembly 30 into contact with the guide jig 60 to bend the electrode tab 40, and a roller jig contacting (S300) that brings the other side of the electrode tab 40 into contact with the roller jig 70. The method of manufacturing a secondary battery may further include a bending position changing (S400) that changes the position of the electrode tab 40 bent in contact with the guide jig 60. The method of manufacturing a secondary battery may further include a jig contact releasing (S500) that separates the cap jig 50 from the cap assembly 20 and separates the guide jig 60 and the roller jig 70 from the electrode tab 40.

In the cap jig contacting (S100), the cap assembly 20 may be in contact with the cap jig 50 that moves in the −X-axis direction to rotate counterclockwise. The cap jig 50 may move while tilted at about 45 degrees in the −Z-axis direction with respect to the −X-axis direction. The cap assembly 20 may be in contact with the cap jig body contact portion 510. The cap jig body contact portion 510 may be provided in a curved shape and may be in contact with the cap assembly 20 at various positions. As the cap assembly 20 is in contact with the cap jig 50 to rotate counterclockwise, the electrode tab 40 connected to the cap assembly 20 may be bent. According to an embodiment, the first electrode tab 41 connected to the cap assembly 20 may be bent to be formed convexly in one direction (e.g., in the +X-axis direction).

In the guide jig contacting (S200), the electrode tab 40 may be bent in contact with the guide jig 60 that moves in the +X-axis direction. According to an embodiment, the guide jig body contact portion 610 of the guide jig 60 may be in contact with the electrode tab one side surface 411 of the first electrode tab 41 to bend the first electrode tab 41 so that the first electrode tab 41 protrudes in the +X-axis direction. The guide jig 60 may move to about ⅔ points (from the end portion of the case 10 in the −X-axis direction to the end portion of the case 10 in the +X-axis direction) of the width (e.g., in the +X-axis direction) of the case 10. Therefore, the bending position B of the first electrode tab 41 may be disposed at about ⅔ points of the width of the case 10.

In the roller jig contacting (S300), the roller jig 70 may be in contact with the electrode tab 40 disposed between the cap assembly 20 and the guide jig 60. The roller jig 70 may be disposed to extend in one direction (e.g., between the −X-axis direction and the +Z-axis direction). The angle A between the direction in which the roller jig 70 extends and the −X-axis direction may be set to range from about 0 degrees to 30 degrees. According to an embodiment, the angle A may be set to range from about 5 degrees to 15 degrees. As the roller jig 70 moves in one direction (e.g., −X-axis direction), the roller jig body contact portion 710 may be in contact with the electrode tab other side surface 412 of the first electrode tab 41. The portion in which the roller jig body contact portion 710 is in contact with the electrode tab other side surface 412 may be disposed at a position (e.g., in the +Z-axis direction) higher than the portion in which the guide jig body contact portion 610 is in contact with the electrode tab one side surface 411. According to an embodiment, the roller jig 70 may move to about ⅗ points (from the end portion of the case 10 in the −X-axis direction to the end portion of the case 10 in the +X-axis direction) of the width of the case 10 while moving in one direction (−X-axis direction). Therefore, the guide jig body contact portion 610 may be disposed closer to the +X-axis direction than the roller jig body contact portion 710.

In the bending position changing (S400), in a state in which the electrode tab one side surface 411 and the electrode tab other side surface 412 of the first electrode tab 41 are in contact with the guide jig 60 and the roller jig 70, respectively, at the bending position B, the case 10 may move downward (e.g., in the −Z-axis direction) or the cap jig 50, the guide jig 60, and the roller jig 70 may move upward (e.g., in the +Z-axis direction). In this way, as the case 10 moves downward or the apparatus 1000 for manufacturing a secondary battery moves upward, the bending position B may move. In this way, as the bending position B moves, the first electrode tab 41 may be bent without being in contact with the case 10. Therefore, a defect rate of the secondary battery 1 can be reduced. The case 10 may move downward or the apparatus 1000 for manufacturing a secondary battery may move upward to the extent that the guide jig 60 and/or the roller jig 70 are not in contact with the cap assembly 20.

In the jig contact releasing (S500), after the contact between the roller jig 70 and the first electrode tab 41 is released, the contact between the guide jig 60 and the first electrode tab 41 may be released, and then the cap jig 50 may be released from contact with the cap assembly 20. According to an embodiment, the case 10 may move upward (e.g., in the +Z-axis direction) or the apparatus 1000 for manufacturing a secondary battery may move downward (e.g., in the −Z-axis direction) before the cap jig 50, the guide jig 60, and the roller jig 70 are released from contact with the cap assembly 20 and/or the first electrode tab 41.

By way of summation and review, when the secondary battery is manufactured, the electrode assembly is disposed inside a case, and the electrode tab electrically connected to the electrode assembly and a cap assembly are connected. While the electrode tab and the cap assembly are connected, the electrode tab may be bent to arrange the cap assembly in the case. However, during bending of the electrode tab, the cap assembly may flip over or the electrode tab may be in contact with the case, resulting in defective products.

In contrast, the present disclosure is directed to providing an apparatus and method for manufacturing a secondary battery capable of preventing an abnormal bending phenomenon of the secondary battery. In addition, the present disclosure is directed to providing an apparatus and method for manufacturing a secondary battery capable of reducing a defect rate of the secondary battery.

However, the effects obtainable through the present disclosure are not limited to the above effects, and other technical effects that are not mentioned will be clearly understood by those skilled in the art from the preceding description of the present disclosure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An apparatus for manufacturing a secondary battery, the apparatus comprising:
a cap jig configured to move and contact a cap assembly;
a guide jig configured to move and contact one side of an electrode tab that electrically connects the cap assembly to an electrode assembly; and
a roller jig configured to move and contact other side of the electrode tab.

2. The apparatus as claimed in claim 1, wherein the electrode assembly is inside a case, and the electrode tab passes through an opening of the case.

3. The apparatus as claimed in claim 2, wherein the electrode tab extends in a direction parallel to a longitudinal direction of the case.

4. The apparatus as claimed in claim 1, wherein the cap jig is configured to move with the cap assembly and the electrode tab is bent.

5. The apparatus as claimed in claim 4, wherein the cap jig is configured to move with the cap assembly toward the guide jig.

6. The apparatus as claimed in claim 1, wherein the guide jig and the roller jig face each other, the guide jig and the roller jig being configured to face opposite surfaces of the electrode tab.

7. The apparatus as claimed in claim 6, wherein the guide jig is configured to move toward the roller jig while contacting one surface of the electrode tab to bend the electrode tab.

8. The apparatus as claimed in claim 7, wherein the guide jig is configured to move parallel to a direction perpendicular to a longitudinal direction of a case accommodating the electrode assembly.

9. The apparatus as claimed in claim 7, wherein the roller jig is configured to move toward the guide jig while contacting another surface of the electrode tab to bend the electrode tab.

10. The apparatus as claimed in claim 9, wherein the roller jig is configured to be in contact with the electrode tab between the guide jig and the cap assembly.

11. The apparatus as claimed in claim 10, wherein an angle between a direction perpendicular to a longitudinal direction of a case and a longitudinal direction of the roller jig is maintained within 20 degrees.

12. The apparatus as claimed in claim 1, wherein the cap jig includes:
a cap jig body; and
a cap jig body contact portion on the cap jig body, the cap jig body contact portion having a curved shape configured to contact the cap assembly.

13. The apparatus as claimed in claim 1, wherein the guide jig includes:
a guide jig body; and
a guide jig body contact portion on the guide jig body, the guide jig body contact portion having a curved shape configured to contact the electrode tab.

14. The apparatus as claimed in claim 1, wherein the roller jig includes:
a roller jig body; and
a roller jig body contact portion on the roller jig body, the roller jig body contact portion being rotatable and configured to contact the electrode tab.

15. A method of manufacturing a secondary battery, the method comprising:
bringing a cap assembly connected to an electrode tab into contact with a cap jig to bend the electrode tab;
bringing one side of the electrode tab connected to an electrode assembly into contact with a guide jig to bend the electrode tab; and
bringing another side of the electrode tab into contact with a roller jig.

16. The method as claimed in claim 15, wherein bringing another side of the electrode tab into contact with the roller jig includes positioning the roller jig in contact with the electrode tab disposed between the cap assembly and the guide jig.

17. The method as claimed in claim 15, further comprising changing a position of the electrode tab bent in contact with the guide jig.

18. The method as claimed in claim 17, further comprising separating the cap jig from the cap assembly and separating the guide jig and the roller jig from the electrode tab.
